(19) United States
(12) Patent Application Publication
(10) Pub. No.: US 2008/0165416 A1
(43) Pub. Date: Jul. 10, 2008

(54) Microscope system and stage control method

(75) Inventors: Naohiro Ariga, Tokyo (JP); Hitoshi Ueda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/008,189

(22) Filed: Jan. 9, 2008

(30) Foreign Application Priority Data
Jan. 10, 2007 (JP) 2007-002742

(51) Int. Cl. G02B 21/26

(52) U.S. Cl. 359/393

(57) ABSTRACT

A microscope system comprises a microscope for observing a sample, a stage on which the sample is mounted, a stage driving unit for moving the stage, and a control unit for controlling the stage driving unit in such a way that acceleration generated by a movement of the stage does not exceed a predetermined value, when the stage is moved with respect to the optical observation axis of the microscope and the stage is relatively scanned by the optical axis.

### CROSS REFERENCE TO RELATED APPLICATION

This application is based on and claims the benefit of priority from the prior Japanese Patent Application No. 2007-002742 filed in Japan on Jan. 10, 2007, the entire contents of which are incorporated by this reference.

### BACKGROUND OF THE INVENTION

1. Field of the Invention

The present invention relates to the control of an electric stage of a microscope system.

2. Description of the Related Art

Record of a whole sample in the form of a digital image may be needed for unpreservable samples such as living cells and soft samples such as a sample in liquid.

There has also been increasing need for the management of a large volume of images of a whole sample by piling them as a database so that a user can search and view a desired sample regardless of the time and location of the search/viewing.

Japanese Patent Application Publication No. 2005-266718 proposes a method for dividing a sample into small sections, obtaining the images of the respective sections by moving the stage, and merging the respective images to manage them as a single image of the sample.

### SUMMARY OF THE INVENTION

A microscope system according to the present invention comprises a microscope for observing a sample, a stage on which the sample is mounted, a stage driving unit for moving the stage, and a control unit for controlling the stage driving unit in such a way, when the stage is moved with respect to the optical observation axis of the microscope and the stage is relatively scanned by the optical axis, acceleration generated by the movement of the stage does not exceed a predetermined value.

In a method according to the present invention for moving a movable microscope stage on which an observation sample can be mounted, a control is performed in such a way that acceleration of the movement of the microscope stage does not exceed a predetermined value.

### BRIEF DESCRIPTION OF THE DRAWINGS

FIG. 1 shows a configuration of a microscope system according to the first embodiment of the present invention.

FIG. 2 shows an outline of an internal configuration of the microscope system according to the first embodiment.

FIG. 3 shows a top view of an electric stage 4 according to the first embodiment.

FIG. 4 shows an internal configuration of an electric stage driving unit 41 according to the first embodiment.

FIG. 5 shows an outline of an internal configuration of a control unit 6 according to the first embodiment.

FIG. 6 shows a route of the movement of stage 31 according to the first embodiment.

FIG. 7 shows direction change of the stage 31.

FIG. 8 shows a flow of the control of the electric stage 4 according to the first embodiment.

FIG. 9 shows the movement of the stage 31 in the vertical direction according to the first embodiment.

FIG. 10 shows a route of the movement of stage 31 according to the second embodiment of the present invention.

FIG. 11 shows the movement of the stage 31 from an n-th scanning line to an (n+2) th scanning line with the direction change shown in FIG. 10.

FIG. 12 shows a route of the movement of stage 31 according to the second embodiment (an example for modification).

FIG. 13 shows a route of the movement of the stage 31 according to the third embodiment of the present invention.

### DESCRIPTION OF THE PREFERRED EMBODIMENTS

The microscope, system according to the present invention comprises a microscope, a stage, a stage driving unit, and a control unit. The microscope is for observing a sample. The sample is mounted on the stage.

The stage driving unit is for moving the stage. The stage driving unit corresponds to the electric stage driving unit 41 in the embodiment described below.

The control unit controls the stage driving unit in such a way that the acceleration generated by the movement of the stage does not exceed a predetermined value, when the stage moves in the vertical direction (X-direction, Y-direction) and the horizontal direction (Z-direction) with respect to the optical observation axis of the microscope, and the stage is relatively scanned by the optical axis. The control unit corresponds to the control unit 6 in this embodiment.

The acceleration generated by the movement of the stage can be suppressed and the distortion of the sample can be prevented with this configuration, when capturing a plurality of images to be merged or with a multipoint observation beyond the viewing field.

In addition, the control unit is capable of controlling the stage driving unit in such a way that the track of the movement of the stage has a curvature. The configuration makes it possible, with a microscope system that scans a whole sample with the movement of the stage, to change the moving direction of the stage without charging stress on a soft sample and a sample in liquid.

The control unit is also capable of controlling the stage driving unit in such a way that the stage moves at a constant speed. The configuration prevents the acceleration from being put on the sample on the stage.

The stage driving unit is capable of moving the stage in the vertical direction along the optical axis. In this case, the control unit is capable of controlling the stage driving unit in such a way that, when shifting the optical axis from a first scanning line to the second scanning line in accordance with the direction change of movement of the stage, the track of the movement of the stage follows an arc of a circle, the curvature of the arc not exceeding a predetermined value.

The configuration in which the stage move in an arc with its direction change makes it possible to reduce acceleration put on the observed sample with the direction change, and to suppress the distortion of the shape of the sample.

Meanwhile, given that the first scanning line is an n-th (n=any integer) scanning line, the second scanning line can be configured as an m-th (m≧n+2) scanning line. The configuration enables the stage to skip one or more line(s) when moving between lines, so that the movement between lines can be made smoothly even when the spaces between the adjacent lines are small.

In addition, the stage driving unit is capable of driving the stage in the direction of the optical observation axis of the microscope. In this case, the control unit is capable of controlling the stage driving unit in such a way that, when the moving direction of the stage is changed in the direction of the optical observation axis, the track of the movement of the stage follows an arc of a circle, the curvature of the arc not exceeding a predetermined value.

The configuration in which the stage moves in an arc with its direction change in the Z-direction as well makes it possible to reduce the acceleration put on the observed sample with the direction change, and to suppress the distortion of the shape of the sample.

The control unit is also capable of controlling the stage driving unit in such a way that the track of the movement of the stage becomes spiral. The configuration enables the stage to move in a spiral without moving over unnecessary parts in capturing the image of a round-shaped sample, avoiding a steep direction change that would damage and distort a soft sample.

The preferred embodiments of the present invention are described in detail below.

### First Preferred Embodiment

This preferred embodiment describes a microscope system in which the moving direction of the stage is changed in such a way that the track of the movement of the stage draws an arc.

According to a conventional method, the moving direction of the stage is changed at a right angle (90°). A sample may be distorted, or misaligned in the case of a liquid sample, due to the shake of the stage or the acceleration put on the sample, the acceleration being caused by the steep change of the moving direction of the stage or sudden start/stop of the movement of the stage.

As described above, the conventional art has not addressed the influence of the acceleration on a soft sample. As a result, a strong acceleration is put on the soft sample by the steep direction change of the stage, causing a damage and distortion to the soft sample.

In this regard, according to this embodiment, the acceleration of the movement of the stage in capturing a plurality of images to be merged or with a multipoint observation beyond the viewing field is suppressed so as to prevent the distortion of the sample.

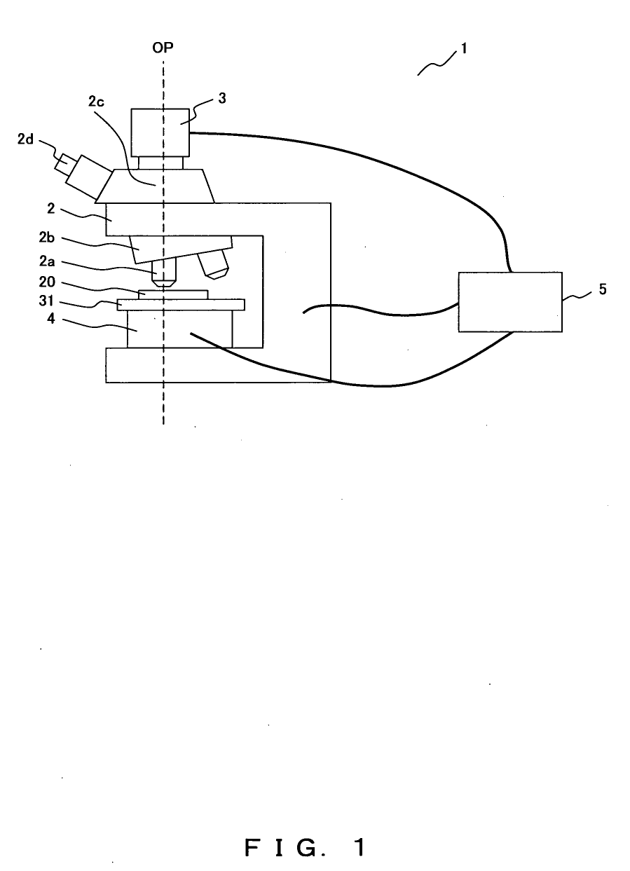

FIG. 1 shows a configuration of a microscope system according to the embodiment. Microscope system 1 comprises a microscope 2, an image capturing unit 3, an electric stage 4 and a host computer 5. The microscope 2 is equipped with the image capturing unit 3 and the electric stage 4. The microscope 2, the image capturing unit 3 and the electric stage 4 are respectively connected to the host computer 5 and controlled by a host computer 6.

The electric stage 4 comprises a stage 31 on which a sample 20 is mounted. An objective lenses switching unit 2b is provided above the sample 20. The objective lenses switching unit 2b is capable of placing a plurality of objective lenses 2a on the observation axis. The upper portion of the main body of the microscope 2 is provided with a lens tube 2c for switching observation axes, an eyepiece 2d for eye observation, and the image capturing unit 3.

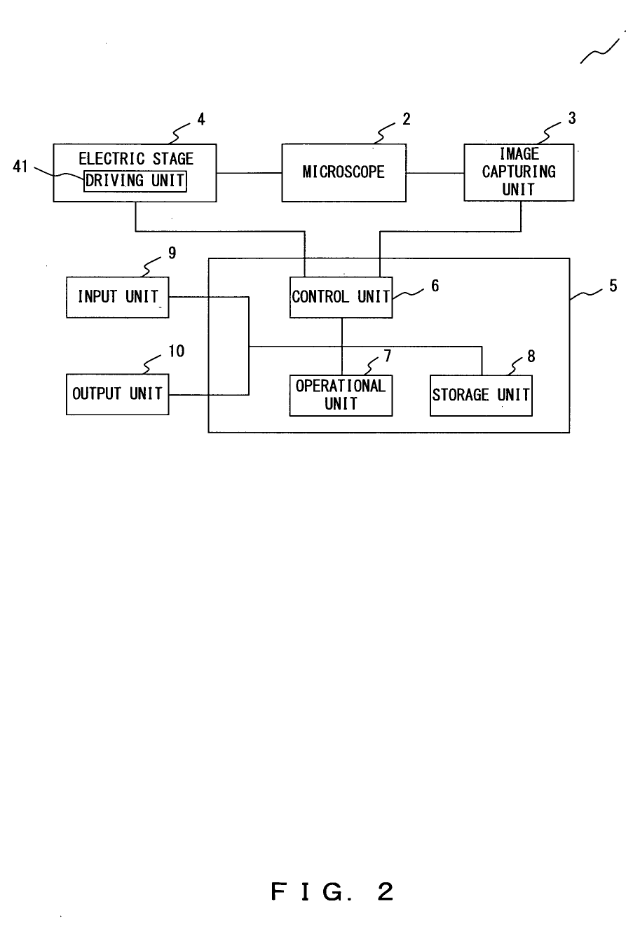

FIG. 2 shows an outline of an internal configuration of the microscope system according to the embodiment. The image capturing unit 3 obtains images from the microscope 2 with the control by the control unit 6, and continuously transmits the images to a storage unit 8 as image data. The image capturing unit 3 is, for example, a digital camera comprising a CCD (Charge-Coupled Device) or a CMOS (Complementary Metal-Oxide Semiconductor).

The electric stage 4 has a stage portion on which the sample is mounted and which moves in the direction of X, Y and Z. The electric stage 4 also comprises an electric stage driving unit 41 that is capable of moving the stage portion to a designated position in, for example, the lateral direction (X-direction), longitudinal direction (Y-direction) and vertical direction (Z-direction), in accordance with the control by the control unit 6.

The host computer 5 mainly comprises the control unit 6, an operational unit 7, and the storage unit 8. The operational unit 7 performs image processing on microscopic images stored in the storage unit 8.

The storage unit 8 is, for example, a temporary memory used for the operation by the operational unit 7, or a mass-storage system such as a HDD (Hard-disk drive) capable of storing a large number of images. The storage unit 8 stores a program for operating the microscope 2 and the electric stage 4. The storage unit 8 may be connected via a predetermined network.

The host computer 5 is also connected to an input unit 9 and an output unit 10. The input unit 9 is, for example, a mouse, keyboard, or a controller panel for controlling the microscope 2.

The output unit 10 is, for example, a display for displaying the images stored in the storage unit 8, or for displaying the GUI for the operator to operate the microscope 2, the electric stage 4 and the image capturing unit 3.

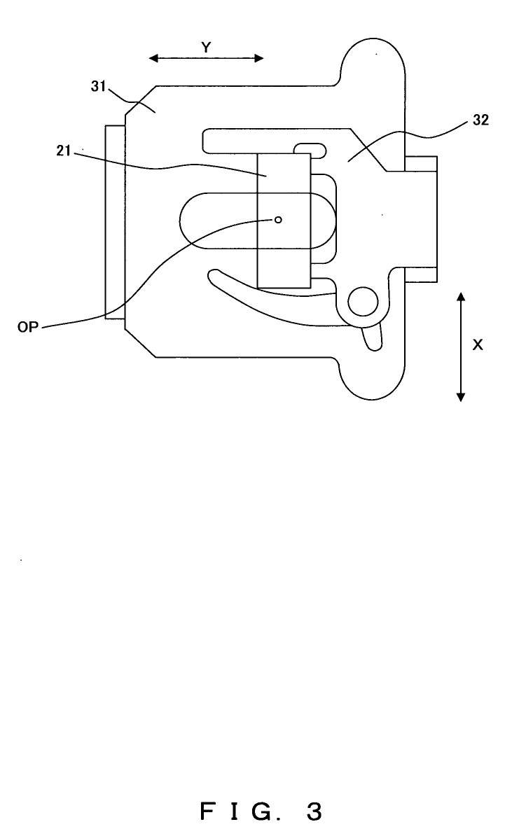

FIG. 3 shows a top view of the electric stage 4 according to this embodiment. In FIG. 3, slide glass 21 is mounted on the stage portion (hereinafter, simply referred to as “stage”) 31 of the electric stage 4. The sample 20 is placed on the slide glass 21 and the slide glass 21 is held and fixed on the stage 31 by a stage clip 32.

The stage 31 can be moved in the X-direction and Y-direction with respect to the optical axis OP of the microscope 2. This configuration enables the optical axis OP to scan the sample with the vertical movement of the stage 31 with respect to the optical axis OP.

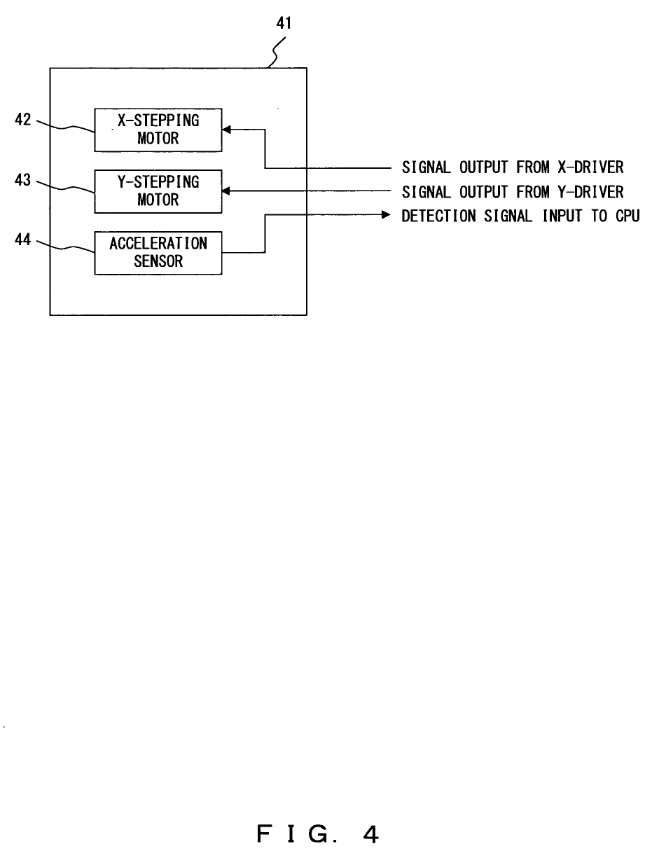

FIG. 4 shows an internal configuration of the electric stage driving unit 41 according to this embodiment. The electric stage driving unit 41 comprises an X-stepping motor 42, a Y-stepping motor 43 and an acceleration sensor 44.

The output axis of the X-stepping motor 42 and the Y-stepping motor 43 rotates, when they receive a pulse signal from the control unit 6, at an angle proportional to the pulse signal.

When the X-stepping motor 42 operates, its rotation drives the stage 31 in the X-direction. When the Y-stepping motor 43 operates, its rotation drives the stage 31 in the Y-direction.

The acceleration sensor 44 detects the acceleration generated by the movement of stage 31. The detection result of the acceleration sensor 44 is fed back to the control unit 6, and the control unit 6 controls the operation of the X-stepping motor 42 and the Y-stepping motor 43, in accordance with the detection result.

The electric stage driving unit 41 may further comprise Z-stepping motor 42 (not shown in the drawings). In this case, when the Z stepping motor operates, its rotation drives the stage 31 in the Z-direction.

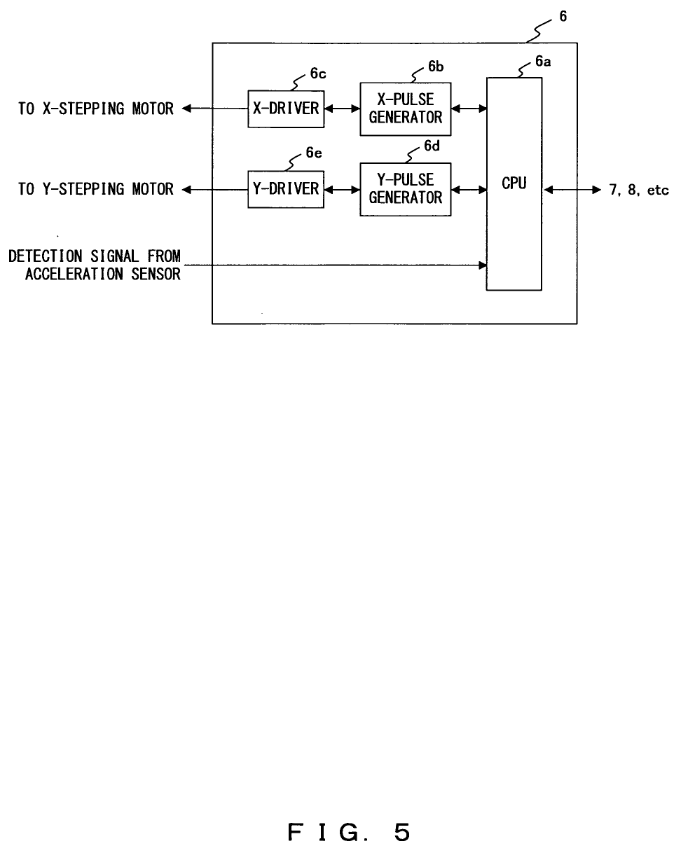

FIG. 5 shows an outline of an internal configuration of the control unit 6 according to this embodiment. FIG. 5 is explained below focusing on the parts that are relevant to the control of the electric stage 4. The control unit 6 comprises a CPU 6a, an X-pulse generator 6b, an X-driver 6c, a Y-pulse generator 6d and a Y-driver 6e.

The CPU 6a inputs driving parameters such as the moving direction, pulse volume, pulse speed, acceleration/deceleration form, to the X-pulse generator 6b. The X-pulse generator 6b outputs signals such as a moving direction signal and a pulse signal in accordance with the driving parameters to the X-driver 6c. The X-driver 6c receives the moving direction signal and pulse signal, and outputs a driving pulse to be applied to the X-stepping motor 42 in accordance with the signals.

The CPU 6a also inputs driving parameters such as the moving direction, pulse volume, pulse speed, acceleration/deceleration form, to the Y-pulse generator 6d. The Y-pulse generator 6d outputs signals such as a moving direction signal and a pulse signal in accordance with the driving parameters to the Y-driver 6e. The Y-driver 6e receives the moving direction signal and pulse signal, and outputs a driving pulse to be applied to the Y-stepping motor 43 in accordance with the signals.

Meanwhile, the CPU 6a receives a detection signal from the acceleration sensor 44, and inputs driving parameters to the X-pulse generator 6b and the Y-pulse generator 6d in order to lower the acceleration of the electric stage or to maintain the acceleration at a constant speed, in accordance with the detection signal. For example, when the CPU 6a determines that the acceleration exceeds a predetermined value (a preset threshold value) on the basis of the detection signal received from the acceleration 44, the CPU 6a performs control to lower the acceleration of the electric stage or to maintain the acceleration at a constant speed.

The control unit 6 may further comprise Z-pulse generator and Z-drive (not shown in the drawings). In this case, the CPU 6a inputs driving parameters such as the moving direction, pulse volume, pulse speed, acceleration/deceleration form, to the Z-pulse generator. The Z-pulse generator outputs signals such as a moving direction signal and a pulse signal in accordance with the driving parameters to the Z-driver. The Z-driver receives the moving direction signal and pulse signal, and outputs a driving pulse to be applied to the Z-stepping motor in accordance with the signals.

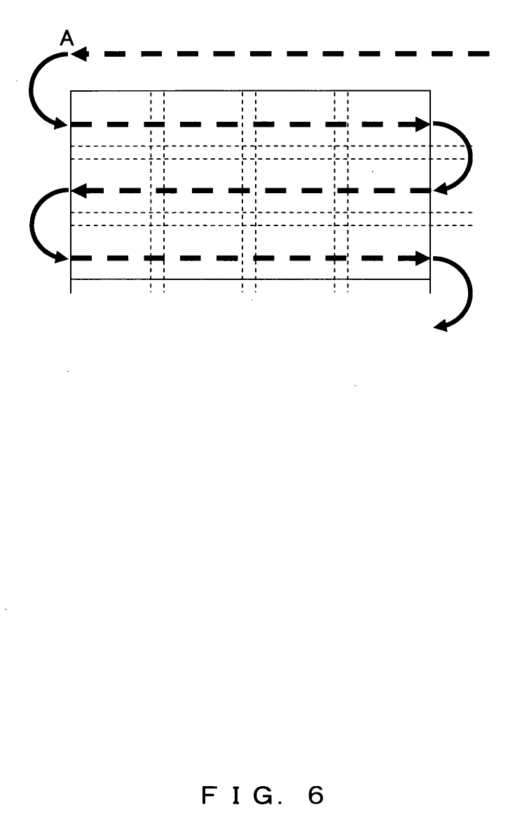

FIG. 6 shows a route of the movement of the stage 31 according to the embodiment. In FIG. 6, an arrow indicates the track (scanning line) of the optical axis drawn by the movement of the stage 31 in the vertical direction relative to the optical axis OP. Each scanning line corresponds to the movement of the stage 31 made between one direction change of the stage and the next direction change (indicated by the broken arrow).

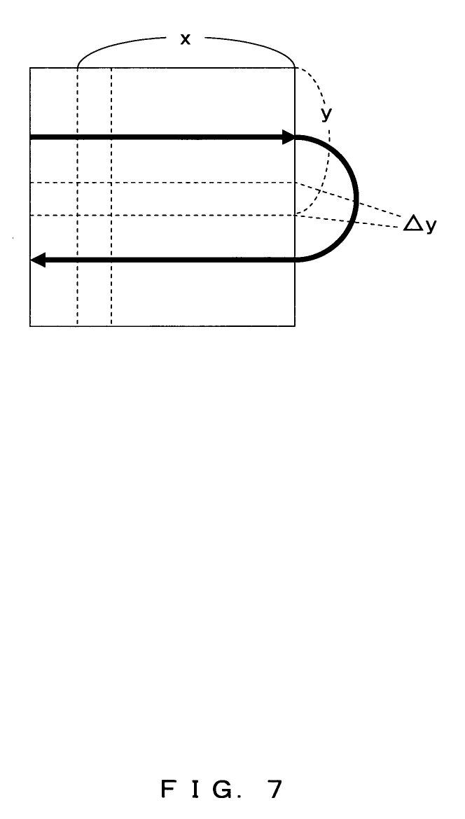

According to this embodiment, as shown in FIG. 6, the direction change of the stage 31 is made in an arc as shown by the solid arrow, so that the direction change can be done smoothly. In FIG. 6, each square delimited by the grid is the viewing field that can be captured by the image capturing unit 3 when the stage 31 is not moving. In FIG. 7, the field corresponds to the area delimited by the length x and the longitude y.

FIG. 7 shows the direction change of the stage 31 according to the embodiment. As shown in FIG. 7, to the next scanning line with direction change, the stage 31 is not moved in a linear manner but is moved in an arc.

In FIG. 7, assuming the longitude of a given grid square as y and the longitude of the part where the grid square and another grid square overlaps as Δy, the stage 31 smoothly moves to the next scanning line while drawing an arc having a radius (y−Δy)/2.

When the direction change of stage 31 is performed in an arc as described above, the acceleration put on the observed sample with the direction change can be reduced, to suppress the distortion of the sample.

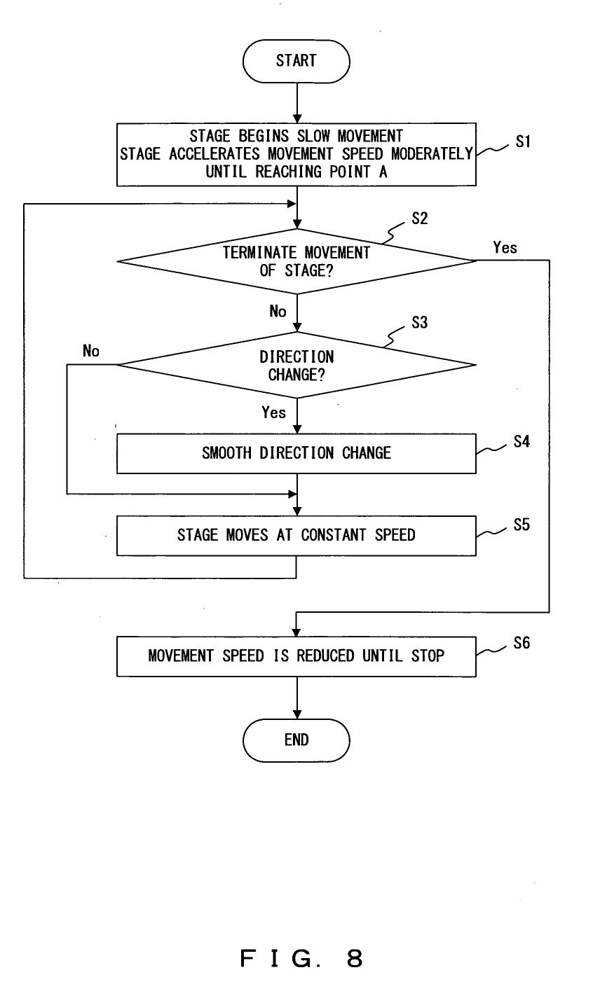

FIG. 8 shows the flow of the control of the electric stage 4 according to the embodiment. The operator first directs the start of the movement of the stage using the input unit 9. The input unit 9 then transmits a stage movement starting signal.

The CPU 6a receives the stage movement starting signal and controls the X-pulse generator 6b to drive the X-stepping motor 4. In this operation, the CPU 6a accelerates the speed of the movement of the stage 31 moderately in accordance with the detection signal from the acceleration sensor 44, in such a way that the stage 31 moves to the point A at a constant speed (Step 1; hereinafter, a step is referred to as “S”). This step makes it possible to lower the stress charged on the observed sample by a sudden start of the movement of the stage 31.

The CPU 6a next determines whether or not to terminate the movement of the stage 31 (S2). When the movement of the stage 31 is to be continued (proceeding to “No” in S2), the CPU 6a determines whether or not to change the moving direction of the stage 31 (S3).

When the direction change of the stage 31 is required (proceeding to “Yes” in S3), the CPU 6a controls the stage 31 to change the moving direction smoothly (S4). The control is made in such a way that, when the movement of the stage 31 turns 180 degrees, the track of the movement follows an arc of a circle, the curvature of the arc not exceeding a predetermined value.

Specifically, the CPU 6a inputs predetermined driving parameters to the X-stepping motor 42 and Y-stepping motor 43, to control the stage 31 to change the moving direction smoothly in an arc.

At this time, the CPU 6a monitors the acceleration of the stage 31 using the acceleration sensor 44, and controls the X-stepping motor 42 and Y-stepping motor 43 via the X-pulse generator 6b and Y-pulse generator 6d in such a way that the acceleration of the stage 31 with its direction change becomes equal or lower than a predetermined value. The control prevents the shape of the sample from being distorted by the acceleration generated by a steep direction change.

Next, when proceeding to “No” in S3, or when the process in S4 is completed, the stage 31 moves at a constant speed with the control by the CPU 6a (S5). Specifically, the CPU 6a inputs predetermined driving parameters to the X-pulse generator 6b to drive the X-stepping motor 42 and to move the electric stage 4 in the X direction, until the next direction change takes place. At this time, the CPU 6a monitors the acceleration charged on the electric stage 4 and controls the X-stepping motor 42 via the X-pulse generator 6b, so that the generated acceleration becomes equal to or lower than a predetermined value.

The processes in S2-S5 are repeated until the completion of the scanning. When the scanning is going to be completed (proceeding to “Yes” in S2), the CPU 6a moderately reduces the speed of the movement of the stage 31 until it stops (S6). Specifically, the CPU 6a monitors the acceleration put on the stage 31 using the acceleration sensor 44, and controls the X-stepping motor 42 via the X-pulse generator 6b so that the acceleration becomes equal or lower than a predetermined value, to moderately reduce the speed of the movement of the stage 31 until it stops. The control prevents the stage 31 from stopping suddenly and causing the acceleration that would distort the shape of the sample.

The above example describes the case where the scanning is carried out in the X-direction and is moved to the next scanning line in the Y-direction with the direction change. The scanning may be configured to be carried out in the Y-direction and to be moved to the next scanning line in the X-direction.

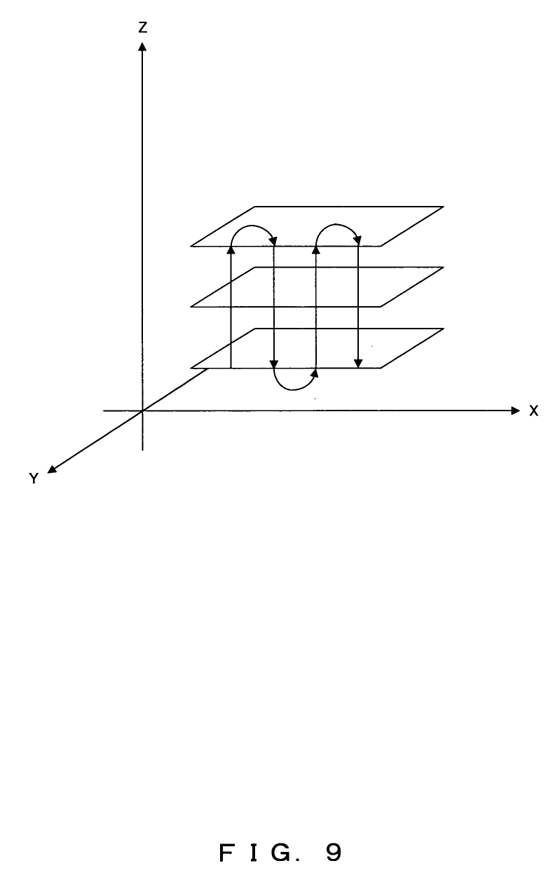

In addition, while the above description uses X-Y directions, the embodiment is also effective for the movement in the vertical direction, as described in FIG. 9.

FIG. 9 shows the movement of the stage 31 in the vertical direction according to this embodiment. As shown in FIG. 9, when the stage 31 moves in the X-Z direction, as well as in the X-Y direction, the direction change is performed smoothly drawing a curve. Specifically, the CPU 6a performs a control in such a way that, when the movement of the stage 31 turns 180 degrees, the track of the movement follows an arc of a circle, the curvature of the arc not exceeding a predetermined value.

In this case, the CPU 6a inputs predetermined driving parameters to the X-pulse generator 6b and Z-pulse generator respectively, to drive the X-stepping motor 42 and Z-stepping motor and to change the moving direction of the stage 31 smoothly in an arc. At this time, the CPU 6a monitors the acceleration put on the stage 31 using the acceleration sensor 44, and controls the X-stepping motor 42 and the Z-stepping motor via the X-pulse generator 6b and the Z-pulse generator, so that the acceleration of the stage 31 with its direction change becomes equal or lower than a predetermined value.

While the track of the movement of the stage 31 draws an arc according to this embodiment, the stage 31 may also be moved, for example, in such a way that the track of the movement draws a parabola or another type of curve, regardless of the route of the movement.

Since the acceleration put on the sample with the start of the movement, direction change, stop of the movement of the stage 31 is reduced as described above, the influence of the distortion of the shape of the sample or misalignment can be suppressed, and, the whole sample can be involved in the movement.

According to this embodiment, the stage does not make a 90-degree turn but the direction change of the stage is made in a smooth way at a constant speed, suppressing the shake of conveyed from the stage to the sample. The force of inertia put on the sample can also be reduced, preventing the distortion of the shape of the sample or the misalignment of the sample.

### Second Preferred Embodiment

When the magnification of the microscope 2 is set high in the first embodiment, the spaces between the scanning lines become small, making it difficult for stage 31 to move with a smooth track to shift the optical axis OP to the next scanning line with the movement of the stage 31.

In this regard, according to this embodiment, the radius of the arc (of a circle) drawn by the track of the movement of the stage with its direction change is configured larger, so that the track of the movement of the stage becomes smooth. In order to extend the radius, the optical axis OP moves from an n-th scanning line to the m-th (m≧n+2) line with the direction change of the stage, according to this embodiment. The description of the configuration of the microscope system in this embodiment is omitted since it is the same as the first embodiment.

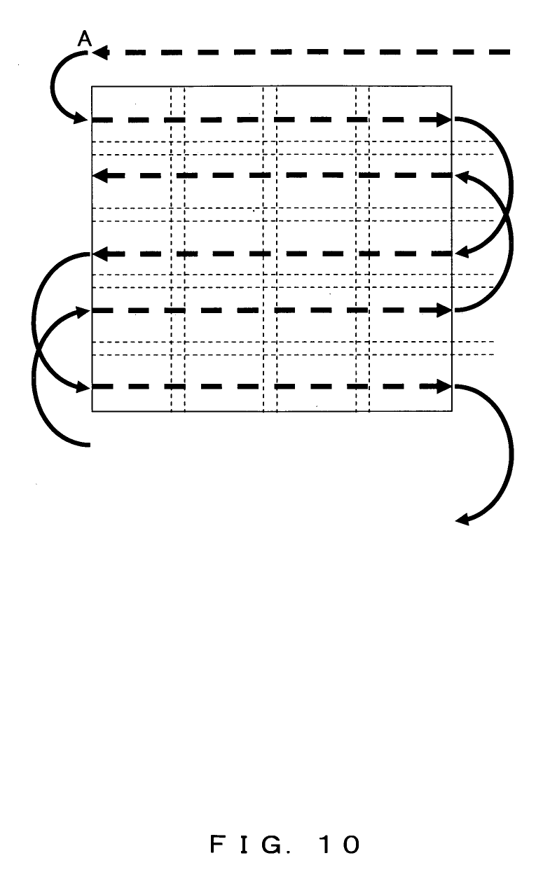

FIG. 10 shows a route of the movement of the stage 31 according to this embodiment. In FIG. 10, the process from the beginning until the stage 31 reaches point A is the same as in the first embodiment. After the stage 31 passes point A, the control unit 6 controls the movement of stage 31 in such a way that the optical axis OP draws the track as shown in FIG. 10. In other words, the optical axis OP moves from an n-th scanning line to an (n+2)-th scanning line.

The movement of the stage 31 is controlled in this way, for the following reason. When the magnification of the microscope 2 is set high, the space between an n-th line and an (n+1) is too small to make a smooth direction change with the track of the movement shown in the first embodiment.

In this regard, in the order of the scanning lines followed by the optical axis OP, a larger radius with a larger action of the direction change can be obtained by moving the scanning line from the n-th line to an (n+2) line, on the basis of the following relationship: the space between an n-th line and (n+2)-th line > the space between an n-th line and an (n+1) line.

The direction change of the stage 31 can be performed smoothly, by controlling the stage to skip a line when the stage moves between lines while spaces between the adjacent lines are small.

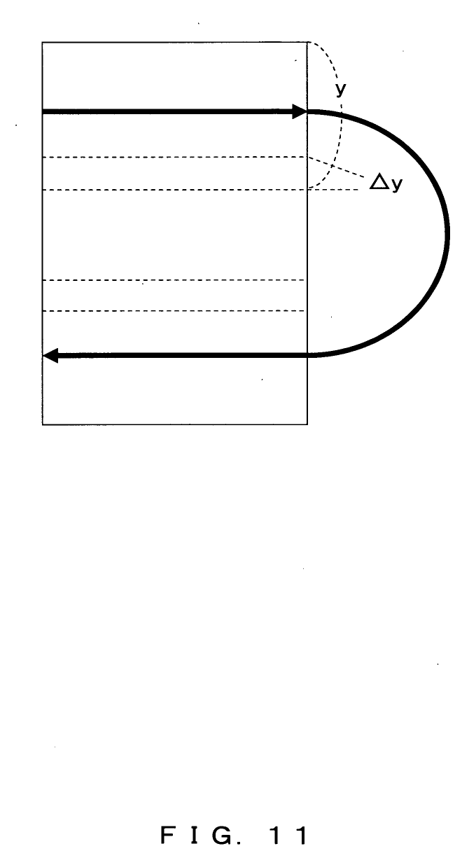

In addition, as shown in FIG. 11, assuming the longitude of a grid square as y and the longitude of the part where the grid square and another grid square overlaps as Δy, the track of the movement of the electric stage 4 skipping a line with its direction change draws an arc having a radius (y-Δy). The radius is twice as long as the radius in the first embodiment, making it possible to reduce the acceleration charged on the sample.

The control unit 6 performs the following controls. The CPU 6a inputs predetermined parameters to the X-pulse generator 6b and the Y-pulse generator 6d to drive the X-stepping motor 42 and the Y-stepping motor 43 and to change the direction of the movement of the electric stage 4 smoothly in an arc having a radius (y-Δy).

At this time, the CPU 6a monitors the acceleration of the stage 31 using the acceleration sensor 44, and controls the X-stepping motor 42 and Y-stepping motor 43 via the X-pulse generator 6b and Y-pulse generator 6d so that the acceleration of the stage 31 with its direction change becomes constant.

While the electric stage 4 skips one scanning line in the example of this embodiment, the number of scanning line to be skipped is not limited to one. The image may be obtained by scanning the whole sample with the movement of the stage 31 skipping two or more scanning lines, for example.

According to this embodiment, when the movement of the stage 31 turns 180 degrees and the track of the movement follows an arc of a circle, the CPU 6a is capable of performing a control to skip as many lines as required in order to limit the curvature of the arc within a predetermined value, if the curvature exceeds the predetermined value. As a result, the direction change of the stage 31 can be done smoothly without a steep movement, preventing the distortion of the shape of the sample or the misalignment of the sample caused by the acceleration or the shake put on the stage.

The scanning is performed in the X-direction and the scanning line is shifted downwards (or upwards) in the Y-direction in the above example. The scanning line may also be shifted alternately downwards and upwards in the Y-direction, while the scanning is performed in the X-direction.

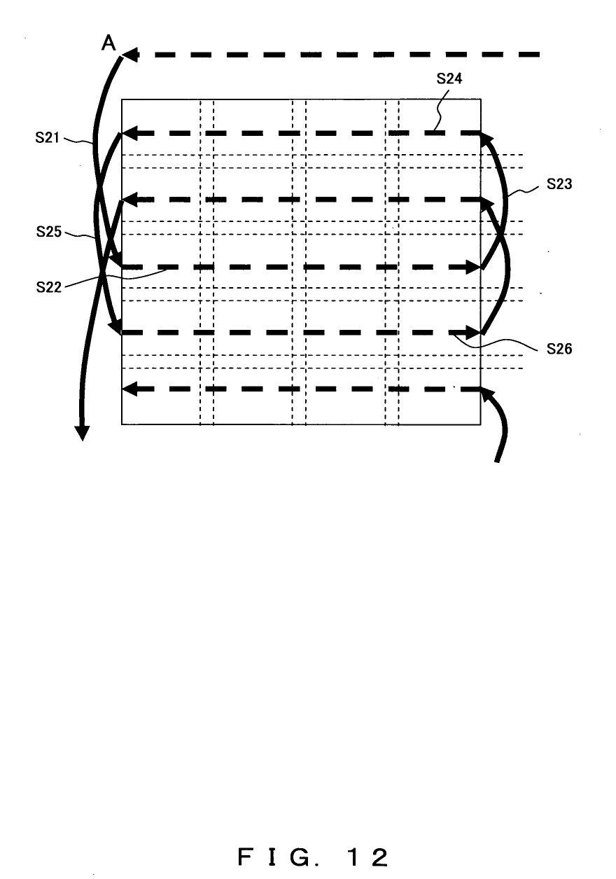

FIG. 12 shows a route of the movement of the stage 31 according to this embodiment (an example for modification). The description of the configuration of the microscope system in this embodiment (an example for modification) is omitted since it is the same as the first embodiment.

The process from the beginning until the stage 31 reaches point A is the same as in the first embodiment. After passing point A, the stage 31 moves with the track shown in FIG. 12, by the control of the control unit 6.

As shown in FIG. 12, the electric stage 4 moves over the whole sample by repeating the upward movement and the downward movement, skipping two lines downwards (S11), moving from left to right (S12), skipping one line upwards (S13), moving from right to left (S14), skipping two lines downwards (S15), and moving from left to right (S16).

According to this embodiment, the repetition of the movement between lines both upwards and downwards enables the stage 31 to move across and scan the whole sample evenly, without missing any scanning line.

In addition, the direction change of the electric stage 4 can be performed smoothly by skipping the scanning lines when the spaces between the scanning lines are small, making it possible to prevent the distortion of the shape of the sample or the misalignment of the sample caused by the acceleration or the shake with the direction change of the stage.

### Third Preferred Embodiment

This embodiment describes a microscope system in which the stage moves in spiral in order to capture the image of the whole of a round-shaped sample. The description of the configuration of the microscope system in this embodiment is omitted since it is the same as the first embodiment.

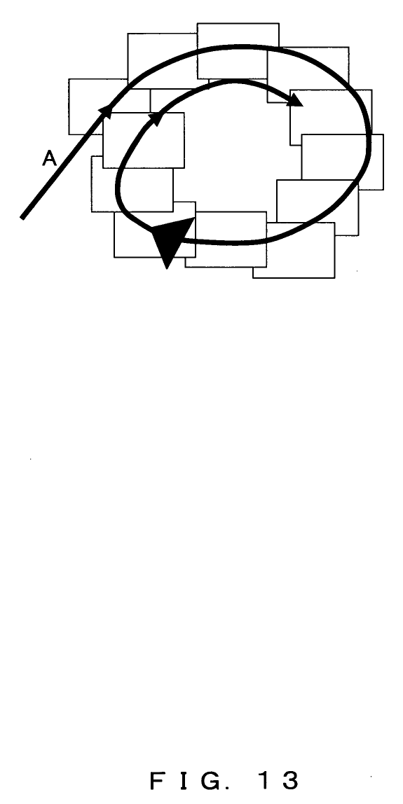

FIG. 13 shows a route of the movement of the stage 31 according to this embodiment. The process from the beginning until the stage 31 reaches point A is the same as in the first embodiment. After the optical axis OP passes point A with the movement of the stage 31, the control unit 6 controls the stage 31 to move with a spiral track as shown in FIG. 13. In FIG. 13, each square delimited by the grid is the viewing field that can be captured by the image capturing unit 3 when the stage 31 is not moving.

The stage 31 moves smoothly inwards from the outer side of the spiral, with the control by the control unit 6. When the stage 31 smoothly moves inwards from the outer side of the spiral, the control unit 6 performs the control so as to maintain the linear speed of the movement of the stage 31 constant.

The control unit 6 performs the following controls. The CPU 6a inputs predetermined parameters to the X-pulse generator 6b and the Y-pulse generator 6d to drive the X-stepping motor 42 and the Y-stepping motor 43 and to move the stage 31 smoothly in spiral.

At this time, the CPU 6a monitors the acceleration of the stage 31 using the acceleration sensor 44, and controls the X-stepping motor 42 and Y-stepping motor 43 via the X-pulse generator 6b and Y-pulse generator 6d so that the acceleration of the stage 31 with its-direction change becomes constant.

This embodiment is effective for a round-shaped sample such as a petri dish. While the stage moves inwards from the outer side of the spiral in the example of the embodiment, the movement may also be done outwards from the inner side.

According to this embodiment, the spiral movement of the stage makes it possible to capture images of a round-shaped sample without moving over unnecessary parts. It also prevents damage that would deform a soft sample, since there is no steep direction change.

As described above, the adoption of the present invention makes it possible to reduce the acceleration put on a sample with the direction change or start/stop of the movement of the stage. As a result, when the whole sample is scanned, the stage can be moved without causing damage that would cause a distortion or misalignment of a soft sample.

According to the present invention, the acceleration of the movement of the stage can be suppressed and the distortion of the sample can be prevented, when capturing a plurality of images to be merged or with a multipoint observation beyond the viewing field.

The present invention is not limited to the embodiments described above, and it is contemplated that numerous modifications and variations may be made without departing from the scope and spirit of the present invention.

What is claimed is:

1. A microscope system comprising:
a microscope for observing a sample,
a stage on which the sample is mounted,
a stage driving unit for moving the stage, and
a control unit for controlling the stage driving unit in such a way that acceleration generated by a movement of the stage does not exceed a predetermined value, when the stage is moved with respect to the optical observation axis of the microscope and the stage is relatively scanned by the optical axis.

2. The microscope system according to claim 1, wherein
the control unit controls the stage driving unit in such a way that a track of the movement of the stage has a curvature.

3. The microscope system according to claim 2, wherein
the control unit controls the stage driving unit in such a way that the stage moves at a constant speed.

4. The microscope system according to claim 2, wherein
the control unit moves the stage in the vertical direction of the optical axis, and
the control unit controls the stage driving unit in such a way that the track of the stage follows an arc of a circle, a curvature of the arc not exceeding a predetermine value, when a scanning position of the optical axis moves from a first scanning line to a second scanning line, with a change of a moving direction of the stage.

5. The microscope system according to claim 4, wherein
the first scanning line is an n-th (n=any integer) scanning line, and the second scanning line is an m-th (m≧n+2) scanning line.

6. The microscope system according to claim 2, wherein
the stage driving unit moves the stage in an direction of an optical observation axis of the microscope, and
the control unit controls the stage driving unit in such a way that the track of the stage follows an arc of a circle, a curvature of the arc not exceeding a predetermine value, when the moving direction of the stage changes in the direction of the observation axis.

7. The microscope system according to claim 2, wherein
the control unit controls the stage driving unit in such a way that the track of a movement of the stage draws a spiral.

8. A method for moving a movable microscope stage on which an observation sample can be mounted, wherein
a control is performed in such a way that acceleration of a movement of the microscope stage does not exceed a predetermined value.

9. The method according to claim 8, wherein
a control is performed, when the movement of the microscope system turns 180 degrees, in such a way that a track of the movement of the microscope stage follows an arc of a circle, a curvature of the arc not exceeding a predetermined value.

10. A microscope system comprising:
a microscope for observing a sample,
a stage on which the sample is mounted,
stage driving means for moving the stage, and
control means for controlling the stage driving means in such a way that acceleration generated by a movement of the stage does not exceed a predetermined value, when the stage is moved with respect to the optical observation axis of the microscope and the stage is relatively scanned by the optical axis.
